(19) United States
(12) Patent Application Publication
(10) Pub. No.: US 2007/0223367 A1
(43) Pub. Date: Sep. 27, 2007

(54) Adaptive Mimo Wireless Communicationsi System

(75) Inventors: Gang Wu, Shanghai (CN); Yueheng Li, Shanghai (CN); Yonggang Du, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/568,276

(22) PCT Filed: Apr. 25, 2005
(86) PCT No.: PCT/IB05/51331

§ 371 Date: Oct. 25, 2006

(30) Foreign Application Priority Data
Apr. 30, 2004 (CN) 200410042222.6

(51) Int. Cl. H04L 1/06

(52) U.S. Cl. 370/216

(57) ABSTRACT

A GMIMO-JD (Generalized Multiple Input Multiple Output—Joint Detection) method to be executed by a receiver for use in MIMO (Multiple Input Multiple Output) wireless communication systems, comprising: receiving the radio signal sent form a transmitter; estimating the propagation channel quality of the radio signal; sending a feedback information to the transmitter according to the estimation result such that the transmitter can choose and reconfigure a GMIMO architecture suitable for the propagation channel according to the feedback information; reconfiguring a GJD architecture suitable for the receiver according to the estimation result; processing the received radio signal from the transmitter by exploiting the chosen GJD architecture.

### FIELD OF THE INVENTION

The present invention relates generally to a communication method and apparatus, and more particularly, to a GJD (Generalized Joint Detection) method and apparatus for use in MIMO (Multiple Input Multiple Output) wireless communication system.

### BACKGROUND ART OF THE INVENTION

During wireless communication process, when signals are propagated over complicated wireless channel, the same transmitted signal will be transmitted along two or more paths and reach the receiver with very slight time difference. These signals passing through multiple propagation channels produce interference to each other, and cause signal fading, which is the so-called multipath fading.

A MIMO system adopts multiple antennas or array antenna to transmit/receive data in the transmitter and receiver. Multiple antennas are sitting in different spatial positions, with different fading features, thus the received signals of adjacent antennas can be approximated as uncorrelated entirely as long as the spacing between adjacent antennas for transmitting/receiving signals in the MIMO system is big enough. The MIMO system takes full advantage of the spatial characteristics of multipath for implementing space diversity transmission and reception.

FIG. 1 illustrates a simplified MIMO system constructed by M Tx antennas and J Rx antennas. Just as stated above, the antenna spacing between the Tx antennas and Rx antennas in the MIMO system in FIG. 1 is generally big enough, to guarantee the spatial un-correlation of signals. As FIG. 1 shows, in the transmitter, MIMO architecture unit 101 first transforms a channel of data stream into M channels of parallel sub data streams; then, multiple access transform unit 102 performs multiplex processing; finally, the corresponding M Tx antennas 103 transmit the signal simultaneously into the wireless channels. Wherein, MIMO architecture unit 101 can adopt any one of the MIMO processing methods, such as STTC (Space Time Trellis Code), space-time block code, space-time Turbo code, BLAST code and etc. While multiple access transform unit 102 can implements TDD, FDD or CDMA.

When the M channels of transmitted signals reach the receiver via multipath (or namely, MIMO fading channel), the signal received by each Rx antenna 104 is equivalent to the overlap-add of M transmitted signals, just as illustrated by the solid arrow in FIG. 1. From FIG. 1, it can be seen that, there exists a wireless channel between any one of Tx antennas and any one of Rx antennas. Assume that the channel impulse response from Tx antenna i to Rx antenna j is denoted as hⱼᵢ (i=1, 2 . . . M, j=1, 2 . . . J, where M and J are the number of Tx antennas and that of Rx antennas respectively), the discrete-time received signal r received by the j^{th} Rx antenna can be represented as:

$${r}_{j , t} = {\sum }_{i = 1}^{M} \sqrt{{E}_{i}} {h}_{j , i} Φ ( {s}_{i , t} ) + {n}_{j , t} \qquad ( 1 )$$

where E₁ is the energy per symbol transmitted at the i^{th} Tx antenna. The total transmission power E₀ can be obtained by overlapping the transmission power of all the M antennas,

$${\sum }_{i = 1}^{M} {E}_{i} = {E}_{o} .$$

In equation (1), s_{1.1} is the symbol to transmitted. Φ(.) is the multiple access transform function, for example, multiple access transform is to multiply the symbols to be transmitted by the spreading codes in terms of CDMA systems. n_{μ}is the complex AWGN with variance as N₀/2, where N₀ is the power spectral density of the noise. From equation (1), it can be easily seen that the signal received at every Rx antenna is not just the overlap-add of M Tx antenna signals, but contains the channel feature hⱼᵢ of M*J wireless fading channels as well.

To correctly recover the data transmitted by the transmitter, the receiver must distinguish the sub data stream sent from each Tx antenna, by taking full advantage of the un-correlation in the wireless channel, after the received signals are processed by multiple access inverse transform unit 105, and this will be done by MIMO detecting unit 106. Meanwhile, MIMO detecting unit 106 needs to combine the M channels of sub data streams into one channel, so as to recover the original data.

In the MIMO system as shown in FIG. 1, the M sub data streams are sent simultaneously into the wireless channels after identical multiple access transform is performed, so all the transmitted signals share the same frequency band. Furthermore, the channel between each Tx and Rx antennas is independent, which means multiple parallel spatial channels are constructed between the receiving and transmitting equipments. Thus, MIMO technique can greatly improve the spectrum efficiency without adding system bandwidth, and the communication capacity increases linearly with the number of Tx and Rx antennas, which helps it to be recognized as the key technology for next generation communication system.

With advantages of large capacity and high speed, MIMO technique has been widely applied in various wireless communication systems. For example, MIMO technique has been employed in many wireless communication systems based on multiple access, like TDMA, CDMA or OFDM and etc. Combined with specific multiple access scheme, MIMO technique can construct MIMO systems like MIMO TDMA, MIMO CDMA, MIMO OFDM and etc.

Irrespective of the above MIMO CDMA system or MIMO wireless communication systems based on other multiple access schemes, system interference is unavoidable. Just like other systems, there also exist MAI (Multiple Access Interference) and ISI (Inter Symbol Interference) caused by wireless propagation over multipath fading channel in the MIMO system. In addition, there is CAI (Co-Antenna Interference), caused by the multiple antennas structure of the MIMO itself. The existence of these interference factors reduces the processing capability of the MIMO system somewhat.

To improve system performance, many methods are adopted in prior arts to mitigate the influences caused by MAI, ISI and CAI. For example, in MIMO TDMA system, the transmitter takes STTC as the MIMO architecture, i.e., extend the original TCM (Trellis Code Modulation) into space dimension and transmit the encoded codes with different antennas respectively. In this way, the receiver can suppress CAI by exploiting space-time decoding (for example, using Maximum Likelihood sequence), and meanwhile combat ISI by adopting equalization (for example, using ML (Maximum Likelihood) sequence or MAP symbol detector). However, since a large mount of redundant information is added into the transmitted signal in terms of STTC, the characteristic that MIMO system capacity can be expanded is not fully demonstrated when the channel condition is good.

Taking another example, the transmitter in MIMO CDMA system uses BLAST technique to generate multiple parallel sub data streams. BLAST processing only reconstructs the signal in space and time dimensions, without adding redundant information, thus the data processing rate of the system can be improved by taking full advantage of the multi-channel parallel wireless channels constructed by MIMO system. The receiver can demodulate the signals on all Tx antennas only by exploiting the un-correlation of the MIMO channels, so the Rx antennas in the receiver shall not be less than the Tx antennas. In conventional receivers, CAI is usually suppressed by using BLAST detection, and then MAI and ISI are combated with multiple-user detection, such as ZF(Zero Forcing), MMSE(Minimum Mean Square Error), SIC (Serial Interference Cancel), PIC (Parallel Interference Cancel), DFE (Decision Feedback Equalizer) and so on. BLAST technique has the ability for processing high-rate data, but its full strengths can only be demonstrated in terms of good channel quality.

From the two aforementioned examples, it can be seen that current MIMO architectures and detection methods have achieved certain results in combating interferences, but they are designed for a particular multiple access system and only the selected processing method can be adopted regardless of the channel quality, thus the system performance fluctuates remarkably, which greatly reduces the adaptation of the system. Moreover, CAI, MAI and ISI are generally cancelled separately and processed independently in prior arts, which deteriorates the overall system performance.

It is, therefore, necessary to propose a GMIMO-JD method for use in MIMO systems with various multiple access schemes, to improve the overall system performance.

### SUMMARY OF THE INVENTION

An object of the present invention is to provide a GMIMO-JD method and apparatus for use in MIMO wireless communication system, which can select the corresponding GMIMO-JD architecture adaptively according to the propagation channel quality, and thus enhance the data transmission rate and improve the communication quality.

Another object of the present invention is to provide a GMIMO-JD method and apparatus for use in MIMO wireless communication system, which is applicable to various kinds of multiple access schemes, like TDMA, CDMA, OFDM and etc.

Yet another object of the present invention is to provide a GMIMO-JD method and apparatus for use in MIMO wireless communication system, which can mitigate CAI, MAI and ISI in an integrated or distributive way, and thus improve system performance.

A GMIMO-JD method for use in MIMO systems in accordance with the present invention, to be executed by a receiver, comprising: receiving the radio signal sent from a transmitter; estimating the propagation channel quality of the radio signal; sending a feedback information to the transmitter according to the estimation result such that the transmitter can select a GMIMO architecture suitable for the propagation channel according to the feedback information; reconfiguring a GJD architecture suitable for the receiver according to the estimation result; processing the received radio signal from the transmitter by exploiting the selected GJD architecture.

A GMIMO-JD method for use in MIMO systems in accordance with the present invention, to be executed by a transmitter, comprising: sending a radio signal; receiving a feedback information from a receiver, the feedback information is derived through estimating the propagation channel quality of the radio signal by the receiver; reconfiguring a GMIMO architecture suitable for the propagation channel according to the feedback information; processing the radio signal to be transmitted by exploiting the GMIMO architecture; sending the radio signal processed by the GMIMO architecture.

Other objects and attainments together with a fuller understanding of the invention will become apparent and appreciated by referring to the following description and claims taken in conjunction with the accompanying drawings.

### BRIEF DESCRIPTION OF THE DRAWINGS

For a detailed description of the preferred embodiments of the invention, reference will now be made to the accompanying drawings in which like reference numerals refer to like parts, and in which:

FIG. 1 is the schematic diagram illustrating a typical MIMO communication system;

FIG. 2 is the block diagram illustrating the transmitter and receiver supporting GMIMO-JD proposed in accordance with an embodiment of the present invention;

FIG. 3 illustrates the transmitting procedure for the feedback information in the GMIMO-JD method proposed in accordance with an embodiment of the present invention;

FIG. 4 illustrates the message encapsulation format for transmitting feedback information in the GMIMO-JD method proposed in accordance with an embodiment of the present invention;

FIG. 5 displays the GMIMO-JD mode selection list proposed in accordance with an embodiment of the present invention;

FIG. 6 is a block diagram illustrating the MIMO architecture in the transmitter and the JD architecture in the receiver when the GMIMO-JD mode is feedback mode;

FIG. 7 is a block diagram illustrating the MIMO architecture in the transmitter and the JD architecture in the receiver when the GMIMO-JD mode is parallel mode;

FIG. 8 is a block diagram illustrating the MIMO architecture in the transmitter and the JD architecture in the receiver when the GMIMO-JD mode is optimum mode;

FIG. 9 illustrates the signaling transmission procedure after the proposed GMIMO-JD method is adopted in UMTS FDD system;

FIG. 10 illustrates the message encapsulation format for transmitting channel impulse response in UMTS FDD system with the GMIMO-JD method as proposed in the present invention;

FIG. 11 is the block diagram illustrating the MIMO architecture of the transmitter in UMTS FDD system when the GMIMO-JD mode is feedback mode;

FIG. 12 is the block diagram illustrating the MIMO architecture of the transmitter in UMTS FDD system when the GMIMO-JD mode is optimum mode;

FIG. 13 is the block diagram illustrating the MIMO architecture of the transmitter in UMTS FDD system when the GMIMO-JD mode is parallel mode.

### DETAILED DESCRIPTION OF THE INVENTION

The main idea of the GMIMO-JD method as proposed in the present invention can be summarized as: the receiver at the receiving side estimates the wireless channel quality from the transmitting side to the receiving side, according to the known signal in the received signal, and feeds the estimation result of the channel quality back to the transmitter at the transmitting side; then, the transmitter at the transmitting side and the receiver at the receiving side process data respectively with the MIMO architecture and JD method most suitable for the current channel condition, according to the estimation result of the channel quality, thus to implement data transmission from the transmitting side to the receiving side optimally.

It should be further noted here that, the BS (Base Station) transmitter can know the downlink channel feature information without uplink feedback, since channel estimation has already been performed during uplink setup procedure in TDD mode. However, better performance can be achieved for TDD mode only when the mobility speed of the UE (User equipment) is relatively low, thus its application range is restrained to some extent. Therefore, in the embodiments of the present invention, MIMO system adopts FDD mode, which has a broader application area.

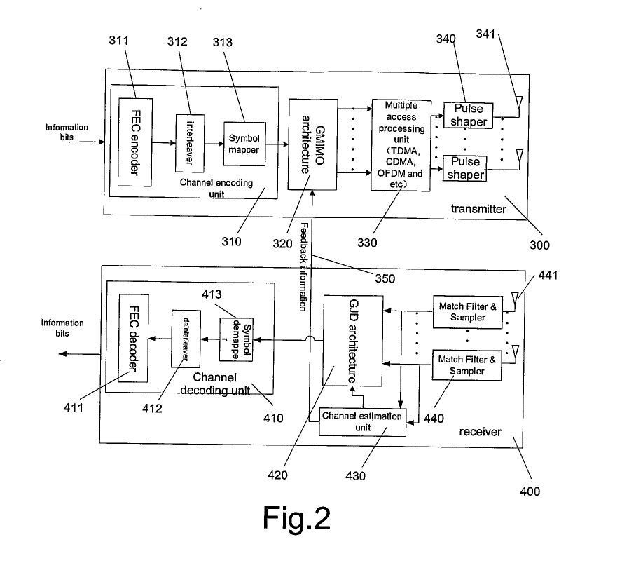

Based on the above assumptions, detailed descriptions will first go to the general idea of the present invention in conjunction with FIG. 2 to FIG. 4, then to the preferred embodiments for the three GMIMO-JD modes as proposed in the present invention, and finally to the signaling implementation of the GMIMO-JD method as proposed in the present invention in UMTS FDD system, by exemplifying the BS transmitter and UE receiver in FDD MIMO system.

FIG. 2 is the block diagram illustrating BS transmitter 300 (at the transmitting side) and UE receiver 400 (at the receiving side) supporting the proposed GMIMO-JD method. Just as displayed in the figure, both BS transmitter 300 and UE receiver 400 have multiple antennas, M Tx antennas 341 and J Rx antennas 441 respectively.

In BS transmitter 300, user data stream is first processed in FEC encoder 311, interleaver 312 and symbol mapper 313, for getting the original data stream to be transmitted. The processing in the three blocks can be regarded as a whole, that is, regarded as a channel encoding unit 310.

After being processed in channel encoding unit 310, the user data stream is fed into GMIMO architecture 320, which may have several MIMO functional blocks for selection, such as STTC, space-time block code, BLAST and so on. According to feedback information 350 sent by the UE via uplink, GMIMO architecture 320 selects and reconfigures a MIMO architecture corresponding to what is indicated in feedback information 350, and processes the original data stream to be transmitted, so as to transform a channel of series data stream into M parallel sub data streams processed by STTC, space-time block code or BLAST.

Next, the M sub data streams are fed into multiple access processing unit 330, for multiple access transform of each branch, for example, multiplex processing of CDMA, OFDM and etc. Finally, after being filtered by pulse shaper 340 respectively, the M braches of signals are transmitted into the wireless channels via the M corresponding Tx antennas 341.

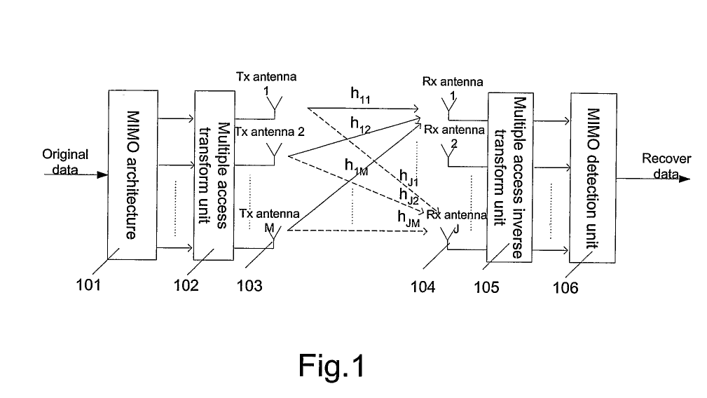

The M transmitted signals reach UE receiver 400 via downlink, and are received by J Rx antennas 441. Similar to the case in FIG. 1, the signal received by each Rx antenna in UE receiver 400 is equivalent to the total sum of the M transmitted signals propagated along different paths. The signals received by the J antennas are filtered and sampled respectively in the corresponding match filter & sample unit 440, to get the J channels of discrete-time signals, wherein the signal received by the j^{th} (j=1, 2, . . . J, J is the total number of Rx antennas) Rx antenna can be expressed as

$${r}_{j , t} = {\sum }_{i = 1}^{M} \sqrt{{E}_{i}} {h}_{j , i} Φ ( {s}_{i , t} ) + {n}_{j , t} .$$

Then, channel estimation unit 430 estimates the feature of each downlink wireless channel (the channel path is shown in FIG. 1) according to the pilot signals in the J channels of time-discrete signals, i.e. computes each channel impulse response function hⱼᵢ in equation (1) and the SINR and the time variance ΔSINR of the SINR for evaluating the channel condition according to the pilot signals.

Channel estimation unit 430 can send the channel estimation results SINR and ΔSINR as feedback information directly to the base station, which however, may put heavy overload of feedback information and increase complexity of the BS transmitter as well. In the embodiments of the present invention, the feedback information mainly includes information about the GMIMO-JD mode, respectively as feedback mode, parallel mode and optimum mode, which will be elaborated below in conjunction with specific embodiments. Herein, the three GMIMO-JD modes are preset by the base station and UE, for indicating the correspondence relationship between the MIMO architecture in the transmitter and the JD method in the receiver in terms of a particular channel quality. In another word, once the GMIMO-JD mode is decided, the MIMO architecture in the transmitter and: the JD method in the receiver can be determined accordingly.

Afterwards, channel estimation unit 430 selects a suitable GMIMO-JD mode according to the values of the SINR and ΔSINR, and then sends the information about the selected GMIMO-JD mode as feedback information 350 to the BS transmitter via the uplink between the UE and the base station. Hence, the transmitter can select a MIMO architecture corresponding to the GMIMO-JD mode. In the receiver, channel estimation unit 430 also sends the information about the selected GMIMO-JD mode to GJD unit 420 containing multiple JD processing modules. GJD unit 420 selects and reconfigures the GJD architecture corresponding to the selected mode, and processes (by using ML detection, ZF-BLE and others) the received J channels of discrete-time signals, to mitigate MAI, ISI, CAI and other interferences in the signals.

After processing the signals, GJD unit 420 transforms the J channels of parallel signals into one channel of series stream and outputs it to channel decoding unit 410. In channel decoding unit 410, the desired user data is recovered after the steam passes through symbol mapper 413 and de-interleaver 412 and ultimately data correction is performed in FEC decoder 411.

The afore-mentioned architectures for the BS transmitter and UE receiver, are combined together through feedback information 350, thus they can jointly select the most suitable signal processing method according to the current channel quality. So, the acquisition and transmission for the feedback information is the key in the GMIMO-JD solution.

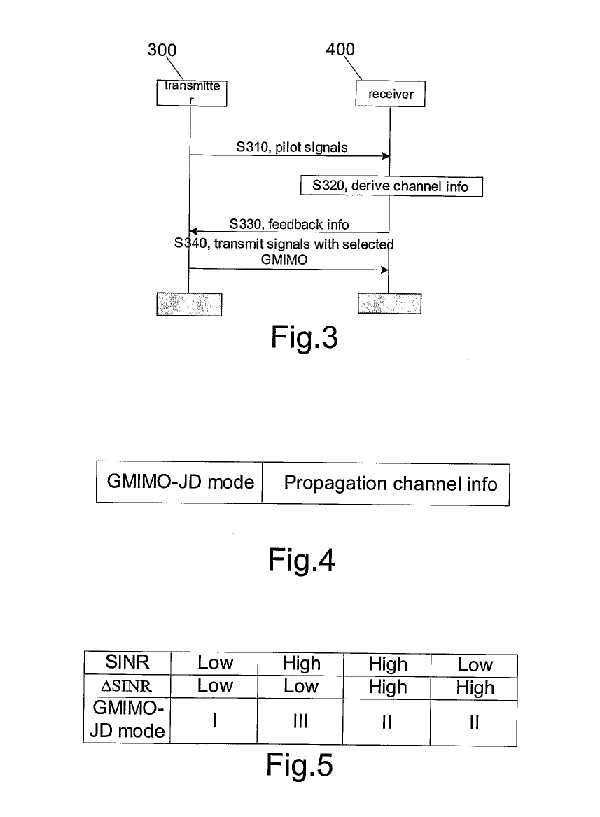

FIG. 3 summarizes the general procedure for transmitting the feedback information in the GMIMO-JD method. As shown in FIG. 3, first, UE receiver 400 receives the pilot signal sent by each Tx antenna 341 from the BS transmitter 300 (step S310); channel estimation unit 430 in UE receiver 400 performs channel estimation on the received pilot signal by using conventional methods, computes the SINR and ΔSINR of the channel, and estimates each propagation channel impulse response hⱼᵢ (step S320). Then, UE receiver 400 selects a suitable GMIMO-JD mode according to the values of SINR and ΔSINR, for example, according to the mode selection list in FIG. 5, and constructs it into feedback information 350 and sends the feedback information to BS transmitter 300 via uplink (step S330). Wherein the message encapsulation format in transmission procedure for feedback information 350 is displayed in FIG. 4. The main part of the message for carrying feedback information 350 is GMIMO-JD mode indication information, and in some particular GMIMO-JD modes, the propagation channel information, or namely the propagation channel impulse response hⱼᵢ, can be included too. Finally, after receiving feedback information 350, BS transmitter 300 immediately selects a MIMO architecture corresponding to the selected GMIMO-JD mode, processes and transmits the data to be transmitted by exploiting this MIMO architecture (step S340). After knowing that the base station has already configured its MIMO architecture, the UE receiver immediately configures its own JD architecture. Thus, the transmitting and receiving sides have jointly constructed the data processing method suitable for the current channel feature.

The above GMIMO-JD mode indicates the correspondence relationship between the MIMO architecture and JD method. From the above introduction to various MIMO architectures and MIMO detection methods, it can be seen that selection of the correspondence relationship varies with different channel quality. The following description will be given to the three GMIMO-JD modes for specific channel conditions: Feedback Mode (Mode I), Optimum Mode (Mode II) and Parallel Mode (Mode II). However, it should be noted that the GMIMO-JD methods proposed in this invention are not restricted to the three modes, and other combinations of GMIMO-JD can also be selected according to the practical channel condition.

Based on the SINR and ΔSINR of the pilot signals measured by channel estimation unit 430, MIMO system can decide to select Feedback Mode, Optimum Mode or Parallel Mode, and the correspondence relationship is illustrated in FIG. 5.

1. Feedback Mode (see FIG. 5)—when SINR and ΔSINR are Low, Select Mode I for the GMIMO-JD Mode

A low SINR indicates that the current channel quality is not very good and thus the FER (frame error rate) of the signal is relatively high. Meanwhile, a low ΔSINR shows that the UE moves slowly, and the channel condition is stable although the channel quality is not ideal. Thus in the UE receiver, the propagation channel impulse response estimated by channel estimation unit 430 will be valid for a certain time period. Moreover, due to strict constraints of size, cost and power consumption, only one (J=1) Rx antenna can be equipped in the UE, thus the diversity gain at the receiving side can't be utilized. Based on these characteristics, in order to improve the Rx diversity gain, the GMIMO-JD mode is selected as Feedback Mode, i.e. feed each channel impulse response on downlink back to the BS transmitter. Selection of Feedback Mode can ideally improve the antenna's diversity gain somewhat with limited facilities.

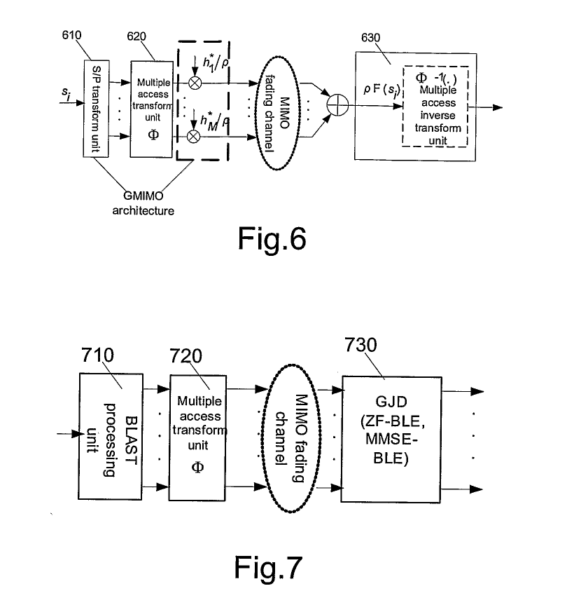

In Feedback Mode, the propagation channel impulse response measured by UE receiver 400 is taken as part of feedback information 350, encapsulated into the propagation channel information portion in feedback information 350 in accordance with the format shown in FIG. 4, and then sent to the BS transmitter. In Feedback Mode, the architectures for the BS transmitter and UE receiver can be given in FIG. 6.

As FIG. 6 shows, S/P transform unit 610 in BS transmitter 300 first transforms the information symbol stream Sᵢ to be transmitted into multiple channels of parallel signals, and then sends them to multiple access transform processing unit 620 for multiplex processing. Next, according to each propagation channel impulse response hᵢ (in this mode, the receiver only has one Rx antenna, so the footnote j in impulse response hⱼᵢ for distinguishing different Rx antennas can be omitted and thus we get the abbreviation hᵢ, wherein the down footnote i indicates different Tx antenna), pre-weighting is carried out for each branch of symbols. That is, each channel of parallel symbols to be transmitted is multiplied by the coefficient h*_{μ}/ρⱼ (the conjugation of the normalized channel impulse response), where

$${ρ}_{j} = \sqrt{{\sum }_{i = 1}^{M} {\vert {h}_{j , i} \vert}^{2}} ,$$

and superscript * is denoted as complex conjugation. It can be seen from FIG. 6 that the signal transmitted from each Tx antenna in BS transmitter 300 has conjugation component of the corresponding channel feature. Herein, S/P transform unit 610 and the portion for pre-weighting each branch of symbol can be regarded as the GMIMO architecture in Feedback Mode.

The M channels of transmitted signals reach the UE via MIMO fading channel. From equation (1) it can be seen that the signal received by the Rx antenna in UE receiver 400 is the product of the transmitted signal and the channel impulse response, and is the linear superimposition of multiple transmitted signals. Additionally, UE receiver 400 only has one Rx antenna, so the received signal naturally is a channel of series signal, and can be denoted as:

$${r}_{t} = {\sum }_{i = 1}^{M} \sqrt{{E}_{i}} {h}_{i} Φ ( {s}_{i , t} ) * {h}_{i}^{*} / ρ + {n}_{t} \qquad ( 2 )$$

From equation (2) it can be seen that the amplitude square of hᵢ can be derived by multiplying the channel impulse response and its conjugate part, and then the received signal rₜ actually is ρΦ(sᵢ) after simple calculation. In this way, the influence caused by the propagation channel has been converted into the diversity gain of multiple antennas, with the result that the energy of received signal is enhanced. Thus, in the UE receiver, GJD architecture 630 can recover the original information symbol only by accomplishing multiple access inverse transform Φ⁻¹ (.) and some interference cancellation operations same as those for single Tx antenna systems. For example, in an OFDM system, GJD architecture 630 implements FFT and some necessary interference cancellation methods, such as series interference cancellation and so on; while in a CDMA system, GJD architecture 630 only need perform JD or other multi-user detection to mitigate MAI or ISI.

2. Parallel Mode (see FIG. 5)—when SINR is High While ΔSINR is Low, Mode III is Selected for the GMIMO-JD Mode

In this case, a high SINR means that the radio channel quality is very good (for example, indoor quasi-static fading), and a low ΔSINR indicates the channel feature is very stable and can ensure an ideal FER, thus the system performance can be enhanced without resorting to feedback information about the channel impulse response. However, The demand for higher data rate is unlimited for the applications such as web browsing, continuous mobile video playing and etc, so the expected target for the system to select GMIMO-JD mode is to realize high-rate data transmission. Therefore, under such channel condition, the most suitable GMIMO-JD mode is Parallel Mode, that is, using BLAST technique to improve the system data processing rate.

The GMIMO-JD architecture based on BLAST technique is illustrated in FIG. 7, wherein BLAST processing unit 710 in BS transmitter 300 can be regarded as the GMIMO architecture in Parallel Mode, and the series symbols to be transmitted are transformed here into multiple channels of parallel signals, then multiplexed by multiple access transform unit 720 and finally sent out via multiple Tx antennas. The multiple channels of transmitted signals reach UE receiver 400 via MIMO fading channel, and multiple Rx antennas feed the received signals into GJD 730 for signal decision and recovery.

For simplicity to describe the GJD processing process, the received signal given in equation (1) can be written as the vector expression:
r=As+n (3)

where A=\sqrt{E₀}ΦH; E₀ is the energy matrix; Φ is the multiple access transform matrix; H is the channel response matrix of the MIMO fading channel obtained through estimating the received pilot signals; s is the symbol vector to be transmitted; n is the complex noise vector.

As stated above, MAI mitigation and BLAST demodulation are usually accomplished in two independent steps in current receivers. But in the MIMO system, MAI mitigation and BLAST demodulation are similar in theory, so the total system performance will be degraded with the method to mitigate interference first and then perform BLAST detection.

In this invention, the system has a powerful processing capability, so we can apply conventional JD algorithms (such as ZF-BLE, MMSE-BLE and so on) directly into GJD 730 according to the channel feature matrix measured by the channel estimation unit. For example, when ZF-BLE is applied, the decision vector of s can be written as:
ŝ=(A′A)⁻¹ A′r (4)

If MMSE-BLE is used, the decision vector of s can be written as:
ŝ=(A′A+N₀I/2)⁻¹ A′r (5)

where superscript ′ is denoted as conjugation transpose; −1 is denoted as pseudo-inverse transform.

Utilization of this JD method has an advantage in that GJD 730 can perform BLAST detection and interference cancellation for MAI and ISI at the same time, i.e. mitigate MAI, ISI and CAI together at the same time, and thus to improve the system performance.

3. Optimum Mode (see FIG. 5)—GMIMO-JD Mode Selects Mode 1, When ΔSINR is High and No Matter Whether SINR is High or Low

In this case, a high ΔSINR shows that the channel feature changes drastically by time, and the wireless channel is possibly subject to the severe influence of multipath fading. With such channel quality, it's very hard to ensure that the measured channel feature is still valid after being fed back to the transmitter, thus the method of channel impulse response feedback can't be used herein. But the statistical feature (such as Rayleigh fading channel feature) of the wireless channel can be known in advance through some necessary measurements, e.g. estimation of the pilot signals. Then, select the MIMO architecture suitable for the statistic feature of the channel from the MIMO architectures of the BS transmitter, and meanwhile apply the detection method suitable for the statistic feature of the channel in the UE receiver. In this way, although no accurate channel feature information is available, we can design the MIMO architecture and JD method based on the statistic feature of the wireless channel, thus to implement optimum channel propagation. Furthermore, to attain better performance, both the antenna diversity gain at the transmitting and that at the receiving sides need to be improved as much as possible. Accordingly, to improve Rx diversity gain, we'd better lower the restrictions on the UE's size, cost and power consumption, and adopt multiple Rx antennas for signal reception.

For example, if the channel is found to be Rayleigh/Rician fading channel through pre-estimation of the statistic feature, STTC can be taken as the MIMO architecture in the MIMO TDMA system. Of course, the architecture can also be extended to other multiple access systems, such as CDMA, OFDM and etc.

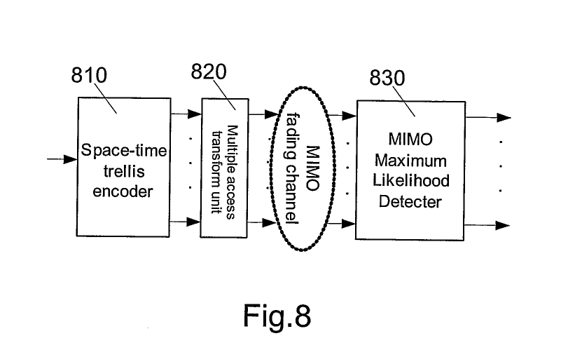

FIG. 8 depicts the GMIMO-JD architecture using STTC. As FIG. 8 shows, BS transmitter 300 first performs coding in STCC coder 810, to transform the series signals into multiple channels of parallel signals, then performs multiplex processing in multiple access transform unit 820, and finally send the signals out via multiple Tx antennas.

The signal arrives at UE receiver 400 via MIMO fading channel. In UE receiver 400, multiple Rx antennas feed the received signals into MIMO ML detector 830 to accomplish signal decision and recovery. During this process, the signal received at the Rx antenna can be expressed by equation (1). For ease of analysis, to represent the received signal in vector form, equation (1) can be converted as:
r=\sqrt{Eₛ}CHs+n (6)

where r is the received signal vector; Eₛ is the energy per transmission symbol; C is the spreading codes matrix; H is the statistical feature of the channel obtained through estimation in advance, the statistical feature of the channel can be represented as the channel response matrix having considered the effects of co-antennas and multipath; s is the transmission symbol vector; n is the complex noise vector. The GJD method employed by UE receiver 400 is MIMO maximum likelihood detection algorithm to combat MAI, ISI and CAI together. Researches demonstrate that the pairwise error probability of transmitting s and deciding in favor of ŝ when applying ML decoder for decoding is upper-bounded by:
P(s→ŝ|H)≦exp(−D²(s,ŝ)·Eₛ/4N₀) (7)

where

$${D}^{2} ( s , \hat{s} ) = {\sum }_{l = 1}^{L} {‖ CH ( l ) ( s - \hat{s} ) ‖}^{2} ,$$

and L is the coding length of symbol s. From equation (7) it can be seen that minimum error probability can be obtained by minimizing P(s→ŝ|H), and thus the design of STTC is to maximize D²(s,ŝ). Therefore, based on the statistical feature H of the channel, we can select the optimum STTC coding scheme so as to design the optimum STTC coding solution that satisfies the maximization requirement of D²(s,ŝ) and minimizes the error probability, i.e. effectively combat all kinds of interferences.

In implementation, the UE receiver gets to know the current channel quality through detecting the pilot signals, and informs the base station via feedback information that the current GMIMO-JD mode is Mode II when the ΔSINR of the channel at this moment is high. The BS transmitter processes the data to be transmitted with the STTC method designed in advance for Rayleigh/Rician fading channel, and sends the data out. The UE receiver detects the received data with ML method.

The foregoing section describes the implementation of the GMIMO-JD method, and elaborates the GMIMO-JD processing method for the three channel conditions as shown in FIG. 5. In practical applications, other MIMO architectures and MIMO detection methods can also be employed according to specific wireless environment. Moreover, as stated above, the GMIMO-JD method is not limited to a certain multiple access scheme, so it can be applied in various wireless communication systems, but the implementations may vary somewhat. For example, as FDD system is concerned, the UE can estimate the channel quality according to the pilot channel signal; but in terms of TD-SCDMA system, the UE obtains the channel quality information by estimating the midamble signal. Furthermore, the physical channel for carrying feedback information 350 and the transmission procedure for upper-layer signaling may be different too.

Based on the protocols of UMTS FDD wireless communication system, the following section will describe how the GMIMO-JD method is implemented in UMTS FDD system, with emphasis on the signaling transmission procedure and the message encapsulation format in the physical layer, again exemplifying the BS transmitter and UE receiver.

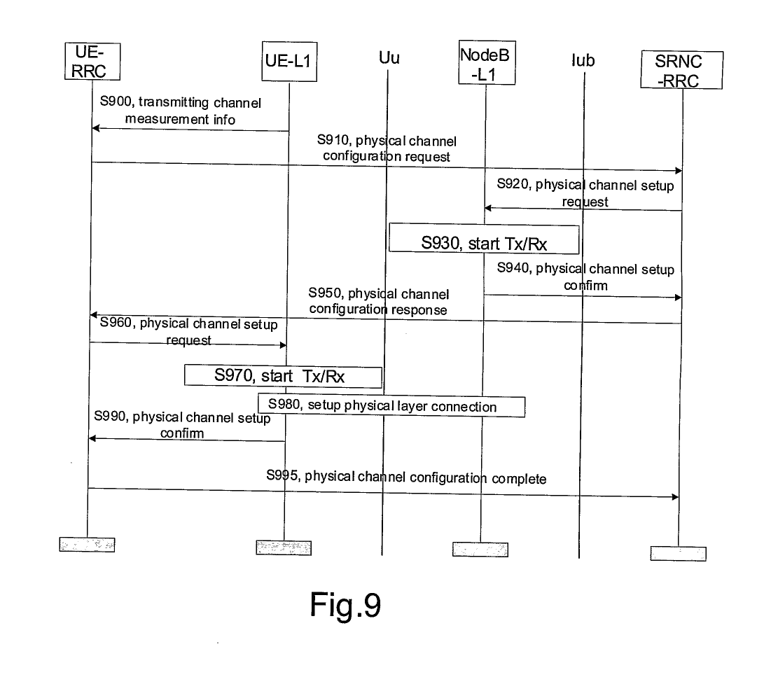

In UMTS FDD system, the signaling transmission procedure for implementing GMIMO-JD between the UE and UTRAN can be illustrated in FIG. 9, wherein Uu is the radio interface between Node B (base station) and the UE, and I_{ub} is the interface between Node B and the SRNC (Service Radio Network Control). A detailed description will be given below to the complete procedure for implementing GMIMO-JD between the UE and the UTRAN, in conjunction with FIG. 9.

1. The UE Decides the GMIMO-JD Mode

It's to be understood by those skilled in the art that CPICH (Common Pilot Channel) is transmitted along with other common downlink channels in UMTS FDD system, to provide phase reference for these downlink channels. The UE can always detect the downlink channel quality by receiving CPICH signals when receiving system broadcast information, no matter whether it establishes connection with the UTRAN or not.

Based on this perspective, in the UMTS FDD system where GMIMO-JD is applied, when the UE starts RCC connection procedure to initiate a call or respond a paging, it first detects the quality of the CPICH channel through the channel estimation unit in the physical layer. The UE's channel estimation unit may estimate the SINR and ΔSINR of the signal in the CPICH, and at the same time can estimate the channel impulse response of the downlink channel so as to send the channel impulse response as feedback information to the UTRAN in the aforementioned GMIMO-JD Mode I—Feedback Mode. Then, the UE's physical layer encapsulates the estimation information about the downlink channel quality into the physical layer measurement message and sends it to the UE's RRC layer (step S900). In the physical layer measurement message are included: number of downlink propagation channels, SINR and ΔSINR of the downlink propagation channel, and the downlink channel impulse response.

The UE's RRC layer (abbr. as UE-RRC, the network layer) acquires the latest channel measurement information from the physical channel measurement message, and selects the corresponding GMIMO-JD mode (such as Feedback Mode, Optimum Mode and Parallel Mode) in accordance with the correspondence relationship of GMIMO-JD as shown in FIG. 5 and the channel quality (i.e. the values of SINR and ΔSINR). Nevertheless, in practical applications, data can also be processed through adopting other modes or other combinations of GMIMO architectures and JD architectures with reference to different channel conditions.

After the GMIMO-JD mode is decided, UE-RRC includes information about the GMIMO-JD mode into the physical channel configuration request, and sends it to the SRNC's RRC layer at the network side (abbr. as SRNC-RRC), to instruct Node B to select a suitable MIMO architecture (step S910). The physical channel configuration request belongs to the messages that interact between the RRC layers, and can be carried by the DPCCH in the physical layer, that is to say, the information about the GMIMO-JD mode is carried over DPCCH.

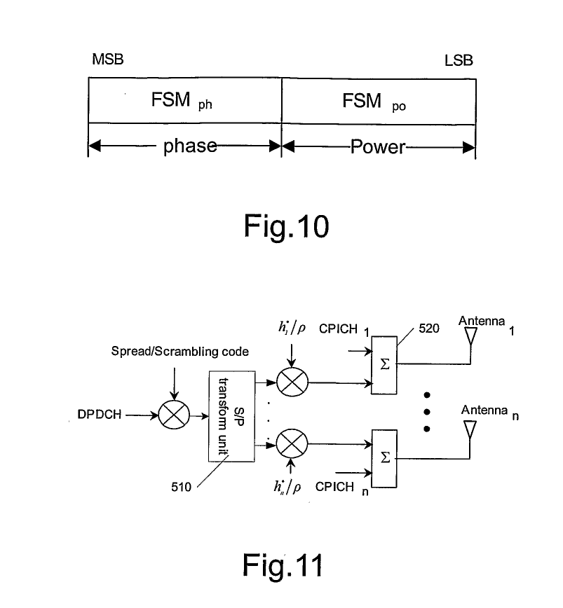

When the GMIMO-JD mode is decided to be feedback mode, we also need to encapsulate the CIR (Channel Impulse Response) into DPCCH and send it to the UTRAN. Here, the encapsulation format of the CIR will be described below in conjunction with FIG. 10.

2. The UTRAN Configures the GMIMO Architecture

After receiving the physical channel configuration request from the UE, the SRNC-RRC separates the information about the GMIMO-JD mode from the physical channel configuration request. If the GMIMO-JD mode is Feedback Mode, CIR information also needs to be separated. Then, the SRNC-RRC sends the physical channel setup request message to the physical layer of Node B (step S920), i.e., transmit the message via the control primitive CPHY-RL-Setup-REQ between the network layer and the physical layer. The physical channel setup request includes conventional information for configuring the physical channel, such as timeslot structure, transport format set and transport format combination set, and information about the GMIMO-JD mode as well. Additionally, when the GMIMO-JD mode is Feedback Mode, CIR information is also included.

On receipt of the physical channel setup request sent by the SRNC-RRC, the physical layer of Node B configures the physical channel immediately according to the radio resource configured in the request, and configures the GMIMO architecture for processing the data to be transmitted (like DPDCH data) in the transmitter according to the information about the GMIMO-JD mode.

Wherein the GMIMO architecture in the transmitter of Node B can adopt different data processing methods for different GMIMO-JD modes. The three GMIMO-JD modes listed in FIG. 5 are still taken as exemplary here. A detailed description will be given below to how the GMIMO architectures corresponding to Feedback Mode, Optimum Mode and Parallel Mode process the data information on the DPDCH in terms of UMTS FDD system, in conjunction with FIG. 11 to FIG. 13.

Afterwards, Node B starts data transmission and reception in the physical layer after successfully configuring the GMIMO architecture in the transmitter in accordance with the above three architectures (step S930). Finally, the physical layer of Node B sends physical channel setup confirmation message to the SRNC-RRC (step S940), to inform the SRNC-RRC that the physical channel has been configured well and is available now.

On receipt of the physical channel setup confirmation message, the SRNC-RRC immediately sends physical channel configuration response message to the RRC layer of the UE that initiates the RRC connection setup request, as the acknowledgement of the physical channel configuration request sent from the UE (step S950).

3. The UE Configures the GJD and Establishes RRC Connection with the UTRAN p On receipt of the physical channel configuration response, UE-RRC sends physical channel setup request to the physical layer (step S960), and configures its physical channel using the radio resource allocated by Node B. The request can transmit message via the control primitive CPHY-RL-Setup-REQ between the physical layer and the network layer. Similar to the case at the UTRAN side, the parameters of the physical channel setup request include timeslot structure, transport format setting and transport format group setting, and information about the GMIMO-JD mode in particular. When configuring the physical channel, the UE sets the specific GJD architecture according to the GMIMO-JD mode. For example, when the GMIMO-JD mode is Feedback Mode, the UE can implement signal recovery and detection with interference cancellation methods same as those in the case of single antenna; when the GMIMO-JD mode is Optimum Mode, the UE can select ML method to process the received signal; when the GMIMO-JD mode is Parallel Mode, the UE can use methods like ZF-BLE or MMSE-BLE to recover the data.

After successfully configuring the physical channel, the physical layer of the UE starts information transmission and reception in the physical layer (step S970). Thus, the connection in the physical layer between the UE and the UTRAN is established (step S980). Afterwards, the physical layer of the UE sends physical channel setup confirmation message to the UE-RRC, to inform the latter that physical connection is successfully established (step S990).

Finally, UE-RRC sends physical channel configuration complete message to SRNC-RRC, informing the latter that RRC connection has been successfully established (step S995) and communication can be carried out now.

From the above description of RRC connection setup procedure in UMTS FDD system, it can be easily seen that information about the GMIMO-JD mode is delivered via the control primitive CPHY-RL-Setup-REQ. Moreover, in the above procedure, steps for determining the GMIMO-JD mode can also be performed in the physical layer of the UE, instead of the RRC layer. In this way, the UE's physical layer only needs to send information about the GMIMO-JD mode, and needn't send SINR for measuring the channel quality and other information to the RRC layer, thus the information delivery load can be alleviated.

The following description will be given to the CIR encapsulation format for encapsulating the CIR into DPCCH to be sent to the UTRAN when the GMIMO-JD mode is Feedback Mode, with reference to the above step S910 in conjunction with FIG. 10. As FIG. 10 shows, the encapsulation format is similar to the D field in FBI (Feedback Information) for closed-loop transmit diversity: FSMₚₒ part, or namely the amplitude of CIR, occupies LSB (Least Significant Bits), for transmitting power setting; FSMₚₕ part, or namely the phase information of CIR, occupies MSB (Most Significant Bits), for transmitting phase setting. UE-RRC encapsulates each downlink channel impulse response in accordance with the format as illustrated in FIG. 10 and sends it to the UTRAN.

In conjunction with FIG. 11 to FIG. 13, the following description goes to how the physical layer of Node B configures the corresponding GMIMO architecture according to the information about the GMIMO-JD mode included in the physical channel setup request after SRNC-RRC sends the physical channel setup request message to the physical layer of Node B in above step S920.

When the GMIMO-JD mode is Feedback Mode, the MIMO architecture in UMTS FDD system is displayed in FIG. 11, wherein the signal to be transmitted by each antenna is pre-weighted by using the CIR in the feedback information as the weight factor, which is similar to the GMIMO architecture shown in FIG. 6. The difference lies in that after the DPDCH data are spread and scrambled (or processed by multiple access transform as shown in FIG. 6), they are then sent to S/P transform unit 510 to implement the transform from a channel of series signal to multiple channels of parallel signals. After being pre-weighted respectively, the multiple channels of parallel signals will be added with the CPICHᵢ corresponding to each antenna in combining unit 520, so as to estimate the variance of downlink channel quality in the UE. In the last, each channel of signal is transmitted from the corresponding Tx antenna respectively.

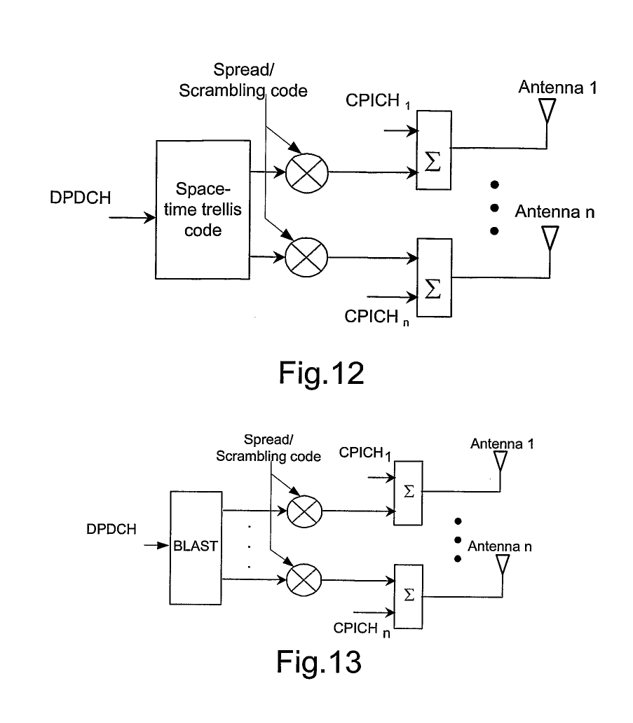

When the GMIMO-JD mode is Optimum Mode, the MIMO architecture in the transmitter of Node B can be shown in FIG. 12, also using STTC method, which is similar to that shown in FIG. 8. From FIG. 12 it can be seen that data on DPDCH are first space-time coded, and a channel of series data are coded into multiple channels of parallel data streams. After the processing of multiple access including spreading and scrambling, each parallel data stream will be added with CPICH signal, and then each branch of signal is transmitted into the radio space via the corresponding Tx antenna.

When the GMIMO-JD mode is Parallel Mode, the MIMO architecture in the transmitter of Node B can be shown in FIG. 13, also using BLAST technique, which is similar to that shown in FIG. 7. From FIG. 13 it can be seen that multiple access transform is performed through spreading and scrambling the DPDCH data in UMTS FDD system, then the CPICH signal corresponding to each branch is added, and the data can be transmitted into the radio space via the corresponding Tx antenna.

While data on DPDCH are taken as the processing object of the GMIMO architecture in the preferred embodiments, it should be understood that the GMIMO architecture can process data on other channels in practical applications, and the processing methods are not limited to the above three.

While the foregoing descriptions have gone to the implementation procedure of the proposed GMIMO-JD method in specific wireless communication systems in terms of UMTS FDD system, it will be clear that the proposed method can also be applied in other kinds of systems, and the system performance won't be affected.

Furthermore, the method proposed in this invention is not limited to applications in the BS transmitter and UE receiver, and it can help improve the uplink quality between the UE and the BS, even be expanded to general transmitters and receivers.

Beneficial Results of the Invention

As described above, with regard to the GMIMO-JD method and apparatus proposed for use in MIMO wireless communication system, the UE receiver feeds the estimation result about the channel quality (i.e. GMIMO-JD mode) back to the BS transmitter, thus the suitable GMIMO-JD architecture can be selected and reconfigured adaptively in the receiver and transmitter, to satisfy the system requirements for different channel quality. Meanwhile, the proposed GMIMO-JD method and apparatus is not limited to a given multiple access system, but can be extended broadly to various systems such as CDMA, TDMA, OFDM and so on, so it's flexible and easy to be implemented. Moreover, in Parallel Mode and Optimum Mode, the GMIMO-JD architecture can cancel CAI, MAI and ISI in an integrated fashion, thus improve the overall system performance. From its implementation procedure in UMTS FDD system it can be seen that the feedback mechanism proposed in this invention can be readily embedded into signaling of conventional systems, without making significant modifications. Accordingly, the communication quality is enhanced, the transmission speed is improved, and better adaptation is achieved in particular.

Although the present invention has been shown and described with respect to exemplary embodiments thereof, it should be understood by those skilled in the art that various changes, omissions and additions may be therein and thereto, without departing from the spirit and the scope of the invention.

1. A GMIMO-JD (Generalized Multiple Input Multiple Output -Joint Detection) method for use in MIMO (Multiple Input Multiple Output) wireless communication systems, to be executed by a receiver, comprising:
(a) receiving a radio signal sent from a transmitter;
(b) estimating the propagation channel quality of the radio signal;
(c) sending a feedback information to the transmitter according to the estimation result, such that the transmitter can choose a GMIMO architecture suitable for the propagation channel according to the feedback information;
(d) reconfiguring a GJD architecture suitable for the receiver according to the estimation result;
(e) processing the received radio signal from the transmitter by exploiting the chosen GJD architecture.

2. The GMIMO-JD method according to claim 1, wherein step (c) includes:
(c1) determining a corresponding GMIMO-JD mode according to said estimation result;
(c2) sending the determined GMIMO-JD mode as said feedback information to said transmitter.

3. The GMIMO-JD method according to claim 2, wherein step (d) includes: reconfiguring said GJD architecture according to said GMIMO-JD mode.

4. The GMIMO-JD method according to claim 3, wherein said estimation result includes: the SINR (Signal Interference Noise Ratio) of the received signal and the time variance ΔSINR of the SINR.

5. The GMIMO-JD method according to claim 4, wherein step (b) includes:
estimating the propagation channel quality of the radio signal according to the pilot signal in said radio signal.

6. The GMIMO-JD method according to claim 5, wherein:
if said SINR and ΔSINR are both lower than a predefined value, said GMIMO-JD mode is Feedback Mode and said feedback information further includes the estimated channel impulse response of said propagation channel.

7. The GMIMO-JD method according to claim 6, wherein multiple access inverse transform is performed on the received radio signal from said transmitter, in said GJD architecture of said receiver.

8. The GMIMO-JD method according to claim 5, wherein:
If said SINR is higher than a predefined value whereas said ΔSINR is lower than a predefined value, said GMIMO-JD mode is Parallel Mode.

9. The GMIMO-JD method according to claim 8, wherein any one of ZF-BLE and MMSE-BLE is performed on the received radio signal from said transmitter, in said GJD architecture of said receiver.

10. The GMIMO-JD method according to claim 5, wherein:
if said ΔSINR is higher than a predefined value, said GMIMO-JD mode is Optimum Mode.

11. The GMIMO-JD method according to claim 10, wherein the ML (Maximum Likelihood) detection is performed on the received radio signal from said transmitter, in said GJD architecture of said receiver.

12. The GMIMO-JD method according to claim 5, wherein said pilot signal is the signal transmitted over the CPICH (Common Pilot Channel) in the UMTS FDD system.

13. The GMIMO-JD method according to claim 12, wherein said step (c) includes:
said transmitter sends said feedback information via the uplink DPCCH (Dedicated Physical Control Channel).

14. The GMIMO-JD method according to claim 13, wherein said step (c) further includes:
embedding said feedback information into the physical channel configuration request signaling to be used by RRC (Radio Resource Controller) in communication link setup procedure.

15. A GMIMO-JD (Generalized Multiple Input Multiple Output-Joint Detection) method for use in MIMO wireless communication systems, to be executed by a transmitter, comprising:
(a) sending a radio signal;
(b) receiving a feedback information from a receiver, the feedback information is obtained through estimating the propagation channel quality of the radio signal by the receiver;
(c) reconfiguring a GMIMO architecture suitable for the propagation channel according to the feedback information;
(d) processing the radio signal to be transmitted by exploiting the GMIMO architecture;
(e) sending the radio signal processed by the GMIMO architecture.

16. The GMIMO-JD method according to claim 15, wherein said feedback information at least includes GMIMO-JD mode and the GMIMO-JD mode is determined through estimating the propagation channel of said radio signal by said receiver.

17. The GMIMO-JD method according to claim 16, wherein the GMIMO-JD mode is Feedback Mode, said feedback information further includes the impulse response of said propagation channel and said step (d) includes:
transforming a channel of signal to be transmitted into multi-channels of-parallel signals;
weighting the multi-channels of parallel signals respectively with the impulse response of the propagation channel.

18. The GMIMO-JD method according to claim 16, wherein the GMIMO-JD mode is Parallel Mode, said step (d) includes:
performing layer space-time coding on said radio signal to be transmitted.

19. The GMIMO-JD method according to claim 16, wherein the GMIMO-JD mode is Optimum Mode, said step (d) includes:
performing space-time trellis coding on said radio signal to be transmitted.

20. The GMIMO-JD method according to claim 16, wherein said radio signal to be transmitted further includes a pilot signal for said receiver to estimate the propagation quality of said radio signal.

21. A receiver, capable of executing GMIMO-JD method in MIMO wireless communication systems, the receiver comprising:
a receiving unit, for receiving the radio signal sent from a transmitter;
a channel estimation unit, for estimating the propagation channel quality of the radio signal and sending the estimation result as a feedback information to the transmitter such that the transmitter can choose a GMIMO architecture suitable for the propagation channel according to the feedback information;
a GJD processing unit, for reconfiguring a GJD architecture suitable for the receiver according to the estimation result, to process the received radio signal from the transmitter.

22. The receiver according to claim 21, wherein said channel estimation unit determines the corresponding GMIMO-JD mode according to the estimation result and sends the determined GMIMO-JD mode as said feedback information to said transmitter, and said estimation result includes: the SINR of the received signal and the time variance ΔSINR of the SINR.

23. The receiver according to claim 22, wherein said channel estimation unit estimates the propagation channel quality of the radio signal according to the pilot signal in said radio signal.

24. The receiver according to claim 23, wherein said GJD processing unit performs any one of multiple access inverse transform, ZF-BLE, MMSE-BLE and ML detection on the radio signal from said transmitter, according to said GJD architecture reconfigured in said GMIMO-JD mode.

25. A transmitter, capable of executing GMIMO-JD method in MIMO wireless communication systems, the transmitter comprising:
a transmitting unit, for sending a radio signal;
a GMIMO processing unit, for receiving a feedback information from a receiver, reconfiguring a GMIMO architecture suitable for the propagation channel of the radio signal according to the feedback information, and processing the radio signal to be sent by exploiting the GMIMO architecture;
wherein:
the transmitting unit sends the radio signal processed with the GMIMO architecture;
the feedback information is obtained through estimating the propagation channel of the radio signal by the receiver.

26. The transmitter according to claim 25, wherein said GMIMO processing unit performs any one of series/parallel transform, weight, layer space-time coding and space-time trellis coding on the radio signal to be transmitted, by exploiting said chosen GMIMO architecture.
